(19) United States
(12) Patent Application Publication
(10) Pub. No.: US 2006/0265931 A1
(43) Pub. Date: Nov. 30, 2006

(54) Fish bite/strike alarm rod holder attachment

(76) Inventors: Steve Mcfadden, Versailles, KY (US); Thomas Brian Bair, Stevenson, WA (US)

Correspondence Address: Thomas L. Bair, 2921 N. Park Ave., Joplin, MO, 64801, US

(21) Appl. No.: 11/439,744

(22) Filed: May 24, 2006

Related U.S. Application Data
(60) Provisional application No. 60/683,870, filed on May 24, 2005.

(51) Int. Cl. A01K 97/12

(52) U.S. Cl. 43/17

(57) ABSTRACT

The present invention is a fish bite or strike alarm which is attachable to multiple types of rod holders. It alerts the angler of a fish striking or tugging on a baited fishing line. An important feature of the present invention is it not attached to the fishing rod, pole or line in any manner. Like no prior art it is attached to rod holders and extends outward in front of the rod holder. It has a unique fishing rod/pole nest which senses fishing rod/pole pressure exerted by the torsional force of the rod caused by a fish bite/strike activity. The nest cradles the fishing rod or pole and transfers torsional movement from the fishing rod or pole and activates a switch by compression force. When the switch is compressed to the actuation point, a standard battery power source signal is sent to any number of alerts devices such as a pizeo sounder, light emitting diodes LED's, wireless remote embodiments containing but not limited to piezo sounders, LED's, vibrators, and voice programmable audio alerts.

### CROSS REFERENCE TO RELATED APPLICATIONS

This application claims the benefit of Provisional Patent Application Ser. No. 60/683,870 filed May 24, 2005 by the present inventor.

### FEDERALLY SPONSORED RESEARCH

Not Applicable

### SEQUENCE LISTING OR PROGRAM

Not Applicable

### FIELD=160/80 CLASS OF INVENTION=43/17

### BACKGROUND OF THE INVENTION

The present invention relates to fishing equipment and more particularly it is attachable to all types of rod holders and it has multiple alarm modes for alerting an angler that a particular fishing rod or pole has a bite or strike. It weighs less than a pound, is electro mechanical and is designed for universal attachment to multiple rod holders that are on the market today. The basic configuration consists of a semi flexible top, a rigid bottom support and two embodiments housing the electrical components. It is not attached or connected to the fishing rod/pole or line in any manner. The alarm is activated by the torsional compression force exerted on the rod or pole by a striking fish or change in line pressure. The increased pressure placed on the rod closes the contacts and triggers the alarm by compression force. The direct contact mode has LED's for night fishing and a pizeo sounder. The remote wireless mode has three alarm options, a piezo LED mode, a vibration mode and an audio mode which the angler can record a personalized alert, e.g. “HEY! WAKE UP! YOU'VE GOTA BITE!”.

### BACKGROUND OF THE INVENTION—PRIOR ART

Various alarm devices have been developed in the prior art for alerting an angler that a fish strike or other alteration of the pressure on the line or rod is occurring. Many of the prior art devices are difficult to set up and most of them must be attached directly to the fishing line. Others rely on the line to be pulled from between electrical contacts, which sets off an alarm and some require the fishing line to pull a trigger or trip an arm and a switch which is connected to an alarm. Several of the prior devices are so sensitive the slightest movement of the fishing line, caused by wind or boat movement, activates the alarm. The prior art of fish bite or fish strike alarms or fish hook setting devices rely on having mechanisms to activate buzzers, lights or vibrators with direct mechanical force or with transmitter and receiver. However none are universal to many rod holders and none are audio programmable by the angler.

Disclosure Document No. 556734 dated Jul. 12, 2004 has been filed with the OIPE to document this present invention as unique as stated in claim No. 1 and claim No. 2. Fish bite alarms heretofore known suffer from a number of disadvantages:

a. Many prior art are attached to the fishing line or a rod or pole which result in:
unsafe automatic hook set alarms
difficulty in set up
tangle with fishing lines
awkward and cumbersome to use
hampers fish retrieval
false fish bite/strike alarms
inconsistent alarm activation
total alarm failure
loss of alarms due to lack of a secured anchor

b. Several prior art alarms rely on the fishing line to keep the electrical contacts separated and rely on the fish bite to remove the line from the electrical contacts to activate the alarm.

c. Some alarms require the fishing line to be looped over a trigger to activate the alarm.

d. Others use the fishing line to trip an automatic fish catch spring resulting in swinging the rod or pole in a backward motion which is a safety problem.

Also several prior art designs require the angler to watch the alert and some raise a flag like on a mail box.

Although the prior art alerts a user to the presence of a fish bite or strike on a fishing line, none are as capable as the present invention as being universal to most rod holders. None of the prior alert systems have a rod/pole nest on the front of the applicable rod holder for consistent and reliable detection of fish bite activity as the present invention. Also none of the prior art alerts have a wireless system for transmitting a signal to a remote location with multiple alert choices, including a self programmable voice alert.

A search of the prior art turned up over eighty one patents. None were designed with multiple rod holder attachment capability. None were designed to be an attachment to existing prior art rod holders that extends forward. None were designed with a remote programmable embodiment. There were five categories of fish bite, strike or hook set alarms or alerts such as: direct fishing line attachments, hook setting devices, unique rod holders, mercury switch technology and miscellaneous methods

Typical Patent with Fishing Line Attachment:

U.S. Pat. No. 4,731,946, issued on Mar. 22, 1988 to Donal J. Blythe and Frank E. J. Sams, disclosed a bite indicator which is connected to a fishing line, with a piezoelectric strain sensing element that causes a light emitting diode to be turned on and/or an audio alarm to sound when the fishing rod flexes. The present invention is not connected to the fishing line in any manner and doesn't rely on an expensive strain sensor.

Typical Hook Setting Disclosures:

U.S. Pat. No. 6,336,287, issued on Jan. 8, 2002 to Herman Lobato, discloses a fish hook setting apparatus for setting a hook and alerting an angler that a bite has occurred. The present invention alerts the angler when a fish bites or strikes and relies on the angler to set the hook rather than an impersonal mechanism.

Typical Unique Rod Holder Disclosures:

U.S. Pat. No. 20040124984, issued on Jul. 1, 2004 to Larry Fuller, discloses a unique fishing rod holder and alert system that cannot be used with any other rod holder. The present invention is universal and can be used with many types of rod holders.

Typical Mercury Switch Disclosures:

U.S. Pat. No. 4,766,688, issued on Aug. 30, 1988 to Richard Hiles, discloses a strike indicator that is a mercury switch mechanism attached to a flexible fishing pole. The present invention is completely separate from the fishing rod or pole which does not interfere with the action and handling of a fishing rod with a fish on the line. The present invention does not rely on mercury switch technology.

Typical Miscellaneous Fishing Alerts:

U.S. Pat. No. 7,293,710, issued on Mar. 15, 1994 to Joseph P. Mills, discloses a fishing pole strike indicator which reacts to movements in the fishing pole detected through a spring mounted probe, rather than directly detecting movement of the pole with a nesting switch as does the present invention.

### BACKGROUND OF INVENTION—OBJECTS AND ADVANTAGES

The objective of the present invention is to provide a reliable fishing accessory for detecting a fish bite or strike. The objectives of this device are to provide for a universal rod holder attachment and a unique rod nest and switch and to provide for multiple alarm modes such as a piezo sounder, LED's, vibration and a programmable audio voice alarm.

As for the background, the present design was developed after losing several fishing rods and experiencing several broken lines as a result of fish strikes on unattended settings on a boat dock at Lake of the Ozarks in Central Missouri. The present invention is an outgrowth of four or five prior attempts to resolve losing fishing rods and broken fishing lines. The first attempt was to mount a nest on a separate pole and locate the nest under the outer most end or tip of a fishing rod. After providing a nest, an electrical switch was attached with lengthy, cumbersome wiring to a 12 vdc battery and a bulky piezo sounder. From this original bulky design, it was recognized the need for a self contained compact system of which the present invention has evolved.

In addition it was found that various alert devices would be desirable, such as a piezo sounders, LED's, vibration and programmable audio which the present invention has incorporated.

A major factor in the present invention is to allow for attachment to all types of rod holders and avoid designing and adding to the current population of over eighteen different types of rod holders.

The present invention has been tested in Missouri, Florida and the state of Washington with outstanding success for all types of fisheries. This present invention assist the angler in determining when a fish bites or strikes the baited line when fishing from the bank, dock, or a boat. It is also equally effective while trolling. Therefore, the objectives and advantages of the fish bite/strike alarm described in the above patent are:

a. Safe and easy attachment to various types of rod holders.

b. No special instructions required to use with a baited rod or pole.

c. Simple sensitivity adjustment for all types of fishing.

d. Aids the hearing impaired without handling a fishing rod or pole.

e. Aids the sight impaired without handling a fishing rod or pole.

f. Creates a positive excitement about fishing to all age groups.

g. Lightweight

h. Can be stored in tackle boxes with ease.

i. Universal use with all types of fishing rods or poles.

j. Can be used during the day or night.

k. Can be used for multiple types of fisheries.

l. Use of standard batteries

### SUMMARY

The present invention is made of durable non corrosive material and is designed for safe and easy set up.

It is small enough to be stored in tackle boxes and is usable in the majority of the rod holders currently on the market and weighs less than a pound. It further can be used season after season with refreshed batteries.

It further has universal features that make it applicable to multiple types of fishing rod holders. It further is not connected to a fishing line, rod or pole. It further is universal for various types of fishing such as boat docks, bank fishing, trolling and fishing from boats. It further has multiple alert modes such as sounders, LED's, vibrators and remote programmable audio alerts. It further enhances the site and hearing impaired to enable catching fish without holding a fishing rod or pole.

### BRIEF DESCRIPTION OF THE DRAWINGS AND PREFERRED EMBODIMENTS

Attachment No. 1 consists of three drawing sheets. Sheet 1 of 3 is an overview drawing showing the present invention is used in relation to a typical fishing rod holder and typical fishing rod or pole.

Sheet 2 of 3 is a drawing of the present invention which identifies two Figures labeled FIGS. 1 and 2.

The description of each part of FIG. 1 follows:

| | |
|---|---|
| 1 | Top Nest |
| 2 | Bottom Support Base |
| 3 | Adjustment Screw |
| 4 | Switch, Piezo Sounder, & Transmitter Embodiment |
| 5 | Anchor Clip |
| 6 | Pop Rivet 5 ea. |

Part 1 is a view of the top nest made of semi rigid material with its outward end shaped to cradle a fishing rod or pole. It is the top nest of the fish bite/strike alarm. It is made of semi rigid rustproof material and inflexible enough to provide a hinge affect when rod or pole movement occurs. The end of the top nest is curved upward to hold a fishing rod or pole, keeping it from sliding off after it has been bated and set to catch a fish. The upward curved portion of the top nest may be a separate part attached with adhesives or pop rivets to the flexible arm made of various light weight materials.

The top nest of the present invention is secured to part 2 with pop rivets part 6. The hinge or fulcrum affect is created near the mid point of part 1 by passing over the adjustment screw part 3 when compression movement occurs caused by movement of nested fishing rod or pole.

Part 2 is the bottom support base made of rigid rustproof material, designed to support a fishing rod or pole and the attachment of the switch assembly embodiment of parts 1 and 4 and provides support for the adjustment screw part 3. It also provides support for anchoring the Fish Bite/Strike Alarm in a rod holder. This bottom support base material can be common to the top nest part 1 or a different type of material. It must be rigid and thin enough to fit inside multiple rod holders without restricting the rod holder cavity which is designed to hold the handle of fishing rods or poles. It also has an elongated slot near the end of the part to provide for an anchor method with bolts provided with several existing rod holders.

Part 3 is a rustproof knurl headed screw to provide sensitivity adjustment capability for multiple types of fishing. It provides for fine adjustment for various types of fishing such as gentle fish bites similar to crappie or for heavy line pull when trolling or when fishing in swift currents.

Part 4 is the embodiment that houses the electrical components for two alert modes. Both contain conventional circuitry including battery connector, battery, switch, piezo sounder, current limiting resistor and two LED's. In the direct alert mode the LED's provide for a visual alert while the piezo sounder provides audible alert. A second alert mode provides for an electromagnetic transmitter and encoder for a wireless signal to a remote receiver FIG. 2.

Part 5 is an anchor mechanism designed to secure the assembly in multiple types of rod holders. Multiple attachment methods are available like Velcro straps, adjustable clamps bolts and flexible wire. These multiple attachment methods are required to assure attachment of various types of rod holders.

Part 6 is a standard rustproof pop rivets are used to hold parts 1 to 2, 4 to 2 and 5 to 2.

The Description of FIG. 2 Follows:

FIG. 2 is the embodiment for the remote receiver containing conventional circuitry including a battery connector, battery, power switch, wireless receiver circuit, decoder, and control circuitry to activate the appropriate alert signal, which may be one or more of the following: a piezo sounder, a vibrator and/or a programmable audio alert. Also included is an LED indicator to identify one of several signal sources.

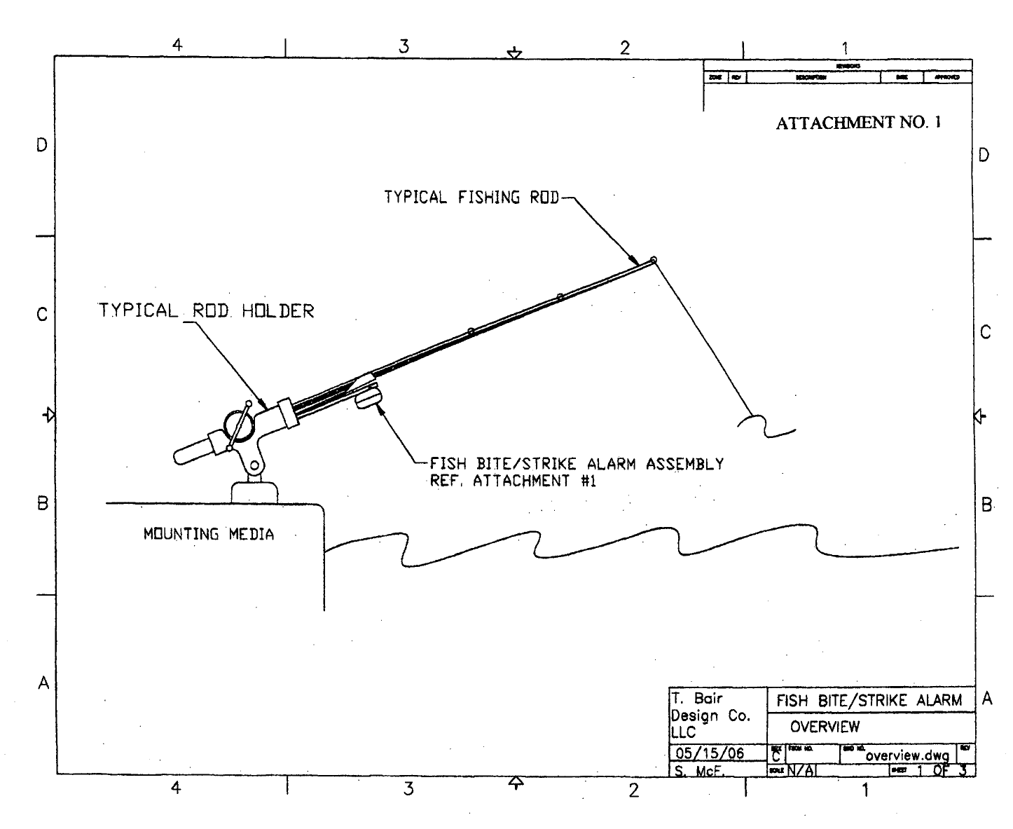

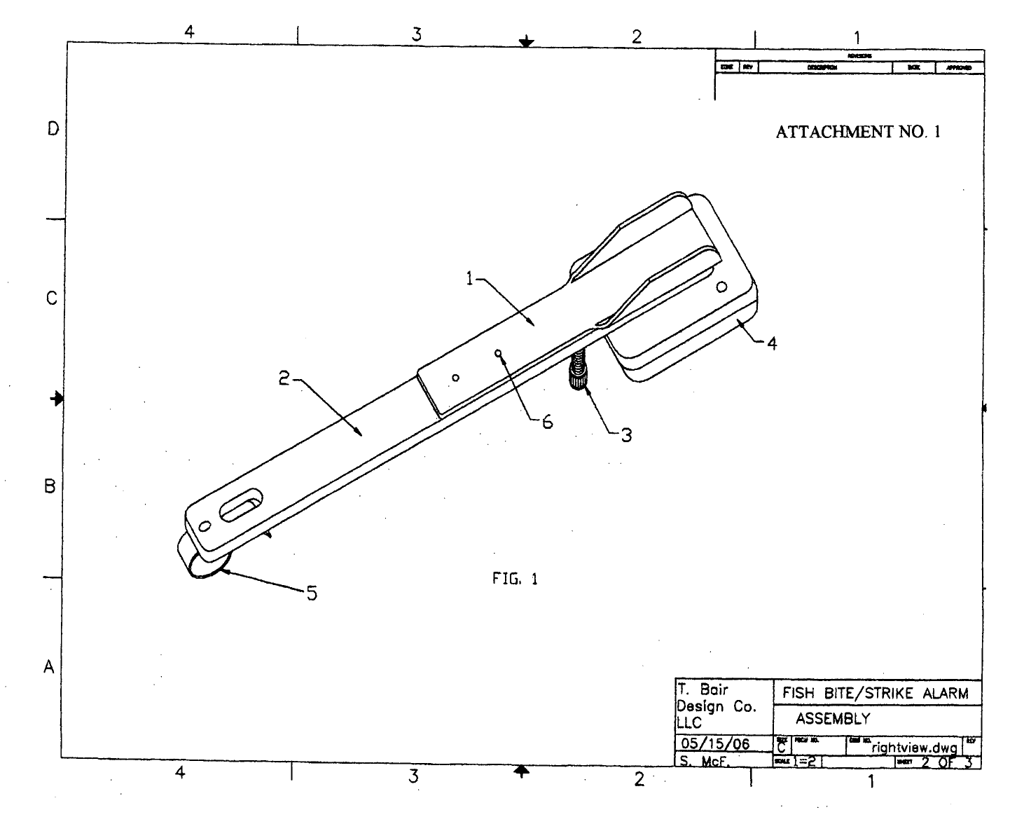

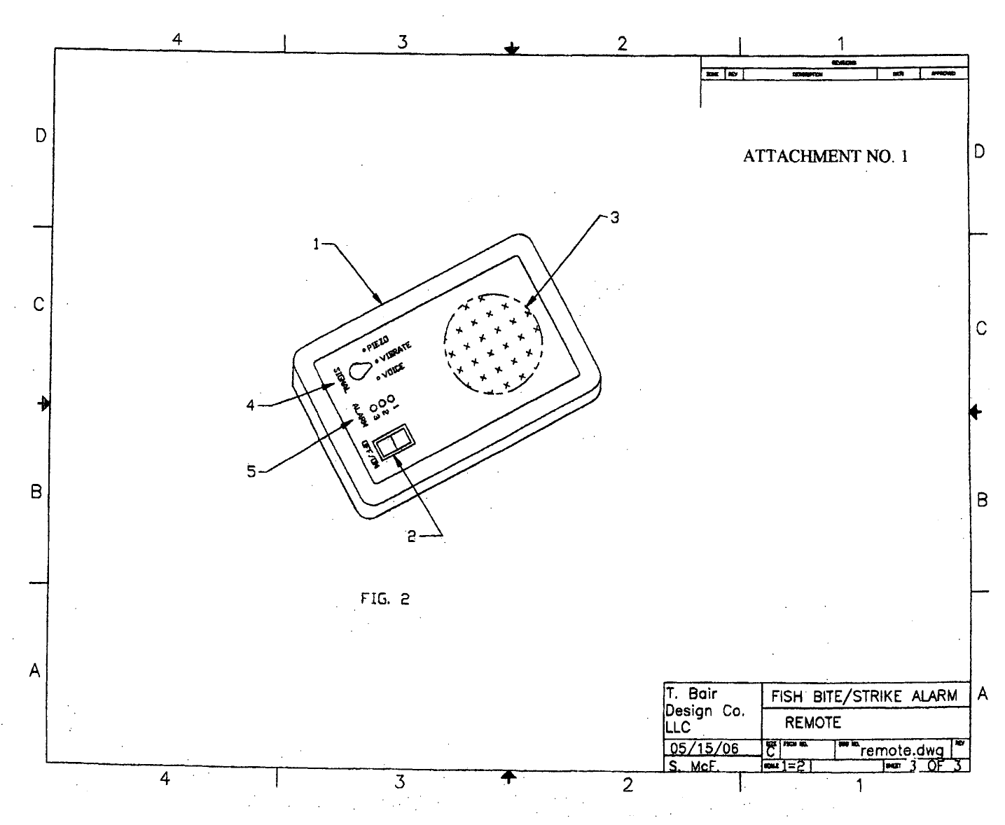

The Description of Each Part of FIG. 2 Follows:

| | |
|---|---|
| 1 | Embodiment for remote operations |
| 2 | Switch for all functions |
| 3 | Speaker for voice alert |
| 4 | Switch for all modes |
| 5 | LED's for one of several alert locations |

Part 1 is the remote embodiment containing three types of alerts, a piezo sounder, a vibrator and a programmable audio receiver with a speaker. It also contains a standard battery power source, a microphone and the necessary components and circuitry for programming and making all components operational.
Part 2 is an on-off switch for all functions.
Part 3 is a speaker for the voice programmed voice alert.
Part 4 is the alert mode selection switch.
Part 5 are LED's for identifying which of the multiple alarms have been activated.

1. a universal fishing rod holder attachment FIG. 1 which extends in front of fishing rod holders comprising:
A bottom stationary part 2 and a top moveable nest part 1 which acts as a fishing rod nest and transfers fishing rod torsional movement thereby delivering a compression force to a switch mounted in embodiment part 4 on the underside of part 2.
When movement compresses the switch sufficient to close the contacts:
Direct alert mode: the LED's provide for a visual alert while the piezo sounder provides audible alert.
Remote wireless mode: provides for an electromagnetic transmitter and encoder for a wireless signal to a remote receiver FIG. 2. The embodiment for the remote receiver FIG. 2 contains the battery, battery connector, power switch, wireless receiver circuitry, decoder, and control circuitry to activate the appropriate alert signal. The available alert signals are a piezo sounder, a vibrator and/or a programmable audio alert and LED's to identify one of several signal sources, whereby indicating a bite or strike on a baited fishing line.

2. An Operator Programmable Voice Audio Module contained in embodiment shown in FIG. 2 which has electrical components comprising:
a. an enclosure to hold all components
b. a microphone to record a short message
c. a programmable memory device for holding a angler's alert message
d. a speaker to broadcast the programmed message
e. a wireless receiver and circuit, decoder and control circuitry
f. a battery and battery connector and power switch
g. a vibrator and piezo sounder
h. light emitting diodes (LED's) and LED display whereby indicating fishing rod compression sufficient to close the contacts of the switch caused by a bite or strike on a baited fishing line.
